(19) United States
(12) Patent Application Publication
(10) Pub. No.: US 2013/0040599 A1
(43) Pub. Date: Feb. 14, 2013

(54) Emergency Call Hybrid Architecture

(71) Applicants: Sascha Berg, Koln (DE); Andrea Sroczynski, Duisburg (DE)

(72) Inventors: Sascha Berg, Koln (DE); Andrea Sroczynski, Duisburg (DE)

(21) Appl. No.: 13/468,146

(22) Filed: May 10, 2012

Related U.S. Application Data
(63) Continuation of application No. PCT/US10/25514, filed on Feb. 26, 2010.
(60) Provisional application No. 61/259,894, filed on Nov. 10, 2009.

(51) Int. Cl. H04W 4/22; H04W 4/02

(52) U.S. Cl. 455/404.2; 455/404.1

(57) ABSTRACT

A hybrid emergency call system that includes a single, third party entity for receiving voice and data signals from a remote location, such as a motor vehicle, deciphering information from the signals, such as the location of the originator of the signals and the nature of the emergency, and based upon at least the location of the originator of the signals, selecting the most appropriate answering unit of the public emergency service such that the deciphered information can be relayed to the public emergency services unit in the preferred form and language of the public emergency services unit using telecommunications and web-interface tools. Subsequently, direct telephonic communication may be established between the motorist and the public emergency services unit.

### CROSS-REFERENCE TO RELATED APPLICATIONS

This is a continuing application, under 35 U.S.C. §120, of copending international application No. PCT/US2010/025514, filed Feb. 26, 2010, which designated the United States, was published in English, and claimed priority to U.S. Provisional Patent Application No. 61/259,894 filed Nov. 10, 2009.

### STATEMENT REGARDING FEDERALLY SPONSORED RESEARCH OR DEVELOPMENT

Not Applicable

### FIELD OF THE INVENTION

The present invention relates generally to emergency call systems, and in particular, to a “hybrid” emergency call system that is especially suitable for operating across a diverse geographical region that allows for emergency voice and data signals from a remote location, such as a motor vehicle, to be relayed to the most appropriate answering unit of the public emergency services system despite any incompatibilities between the communications interfaces or speaking languages of the motorist and the selected unit of the public emergency services system.

### BACKGROUND OF THE INVENTION

Motor vehicle emergency call systems are known in which a person in distress can get relatively immediate aid and rescue following a motor car accident or other emergency situation that occurs while the motor vehicle is on the roadways. Specifically, in such systems, a wireless radio transmitter or transponder box is installed and located somewhere inside the motor vehicle and, based upon pre-determined circumstances or events, for example, deployment of an airbag, immediately and automatically generates and transmits a radiating distress signal or voice call to one or more remotely located central call centers or stations that typically have a standby dispatch system manned by call center personnel. Data, such as the accident location, the nature of the accident or the situation in which the motor vehicle is in, and the type of assistance that is required, may also be transmitted simultaneously with the initial distress signal depending upon the sophistication and complexity of the system and its motor vehicle tracking and navigation control capabilities. Thus, motor vehicle emergency call systems provide an invaluable lifesaving advantage by initiating an emergency signal almost instantaneously and in circumstances where a person is incapacitated or otherwise unable to call for help.

Some of the existing systems that are installed inside motor vehicles are also capable of providing pre-determined automated instructions, assurances, navigational indicators, or other useful information to the driver and/or passenger of the motor vehicle based upon the emergency condition of the vehicle prior to when emergency help arrives.

In some applications, the wireless radio transponder is capable of both transmitting and receiving signals thereby providing a two-way communication device that allows for the emergency response source (e.g. hospital, police or fire emergency department) and/or the central call center to actively, remotely interrogate the motor vehicle emergency system or establish direct communication with the driver or a passenger of the motor vehicle. Accordingly, additional information can be acquired for assessing the emergency situation and determining the appropriate emergency response. Critically, the two-way communication device can also be used to provide immediate, real-time help and lifesaving instructions to the driver or passenger of the motor vehicle prior to when emergency help arrives to the actual location of the motor vehicle.

Accordingly, adapting emergency call systems for use in a vehicle is complex and unique challenges arise in managing remote transfers of data from a disabled or damaged vehicle whereby the emergency information routing systems differ among the various regions that a vehicle can travel. The user interfaces alone are time-consuming to develop and to operate.

A number of advances have been made to effectively and safely manage the multitude of incoming distress signals and data at the receiving end of the emergency call systems, including the establishment and implementation of specific protocols and communication networks for responding to the signals. For example, these system protocols are capable of determining a priority for responding to the various incoming signals, deciphering whether or not an emergency has occurred despite errors in the signal or disablement of the emergency call device inside the vehicle, and allocating the distress signal and data to the appropriate emergency response team. Various system and call flow architectures exist that have been set aside and segregated specifically for the receiving side of the emergency call systems. These system architectures involve either government organized public emergency services, private third-party emergency services, or an interrelated combination of both.

For example, in Europe, the European commission currently has two approaches or pathways available for receiving incoming emergency calls and initiating an emergency response. The first approach is the public emergency services system, the “eu112” call, whereby a voice call is made by dialing the “112” number using a fixed or mobile phone. Data regarding the emergency event and the vehicle status is transferred directly to the remotely located central call centers or stations, referred to as a “Public Safety Answering Point” (PSAP), using an in-band modem provider solution. The “eu112” system is very similar to the “911” emergency services system utilized in the United States. The “eu112” emergency call system is a public service available to everyone in any country in the European Union (EU) and across the European continent. It is free of charge and provided at a relatively low cost. However, because the system is offered on such a wide scale and over an entire region, it is difficult to handle and direct the influx and high volume of information and provide quality control. In addition, because the “eu112” system is a single system that is available to all of the countries in the EU, the particular routing interface and native language of the PSAP that automatically receives the call due to its proximity to where the emergency event occurred, may be different than the routing interface of the motor vehicle or the native language of the driver or passenger thereby stifling any possible or efficient communication. In such a region-wide system, there exists a myriad of local emergency response centers, or PSAPs, that have varying levels of technical capability in their infrastructures, protocols in their operations and training, and funding available for system enhancements and/or integration, that make region-wide deployment of a uniform emergency system virtually impossible.

Alternatively, in the second approach, a “Third Party Service Provider” (TPSP) receives the voice call and transmitted data first at the call center or station before the information is relayed to the PSAPs. This allows for the TPSP to use some kind of screening process for screening the incoming signals and calls and to gather sophisticated and complex information that is not typically capable of being gathered by a public service type of option. Further, due to the initial screening process, the TPSP can determine the appropriate PSAP to which the information should be routed in appreciation of any language barrier that may be present. As a result, the information subsequently relayed to the PSAPs is of much better quality, reliability and succinctness after having been filtered and initially handled by a TPSP. However, typically these services are not direct, are not free of charge and cost more to implement as they involve multiple parties and complex communication resources.

Therefore, a need exists to overcome the problems with the prior art as discussed above.

Accordingly, it would be beneficial to provide a “hybrid” emergency call system, or solution, between approaches that incorporates the low cost benefits of the regional, public service approach and the comfort, reliability and quality of the third part service provider approach.

Thus, a need exists to overcome the problems with the prior art systems, designs, and processes as discussed above.

### SUMMARY OF THE INVENTION

Embodiments of the present invention provide a hybrid emergency call system, comprising a third party service center for receiving an incoming wireless emergency signal from a remote location. The third party service center comprises at least one server that decodes information from the incoming wireless emergency signal including the location of the signal, at least one server that selects the appropriate public emergency call response center based upon the location of the signal, at least one server that converts the incoming wireless emergency signal into at least one audio file in the speaking language of the selected public emergency call response center, and wherein the at least one audio file is relayed to the selected public emergency call response center over a telecommunications channel.

In accordance with another feature, an embodiment of the present invention includes wherein the incoming wireless emergency signal is coming from a motor vehicle at the location.

In accordance with another feature, an embodiment of the present invention includes wherein the incoming wireless emergency signal is comprised of a voice signal portion and a data signal portion.

In accordance with another feature, an embodiment of the present invention includes wherein the data portion is the portion of the incoming wireless emergency signal that indicates the location of the signal.

In accordance with yet another feature of the present invention, the data portion of the incoming wireless emergency signal indicates the nature of the emergency and the condition of the motor vehicle.

In accordance with yet another feature of the present invention, the data portion is the portion of the incoming wireless emergency signal that is converted into the at least one audio file.

In accordance with yet another feature of the present invention, the at least one audio file is comprised of one or more announcements associated with the information decoded from the incoming wireless emergency signal.

In accordance with yet another feature of the present invention, the third party service center puts the voice portion of the signal on hold until after the at least one audio file is relayed to the selected public emergency call response center.

In accordance with yet another feature of the present invention, the third party service center releases the voice portion of the signal from being on hold and establishes a direct connection between the voice portion of the signal and the selected public emergency call response center after the at least one audio file is relayed to the selected public emergency call response center.

In accordance with yet another feature of the present invention, in addition to receiving the data portion of the incoming wireless emergency signal in at least one audio file, the selected public emergency call response center directly also receives the data portion through at least one web interface.

In accordance with yet another feature of the present invention, the at least one web interface is a preferred interface of the selected public emergency call response center.

In accordance with yet another feature of the present invention, the at least one web interface is a collaborative agreed interface of the selected public emergency call response center and the third party service center.

In accordance with another feature, an embodiment of the present invention includes wherein the at least one web interface is a high secure web portal in association with the third party service center wherein the selected public emergency response center has secured access to web portal.

In accordance with yet another feature, an embodiment of the present invention includes wherein the third party service center further comprises a middleware element wherein the selected public emergency call response center obtains a subscription to the middleware element such that the third party service center publishes the data portion of the incoming wireless emergency signal in the preferred web interface.

In accordance with another feature of the present invention, wherein the selected public emergency response center is given an access code in the at least one audio file for accessing the web portal.

Additional advantages of the present invention will be set forth in the Detailed Description which follows and may be understandable from the Detailed Description or may be learned by practice of exemplary embodiments of the invention. Still other advantages of the invention may be realized by any of the instrumentalities, methods or combinations particularly pointed out in the claims. Although the invention is illustrated and described herein as embodied in one or more exemplary embodiments, it is, nevertheless, not intended to be limited to the details shown because various modifications and structural changes may be made therein without departing from the spirit of the invention and within the scope and range of equivalents of the claims. The system and method of operation of the invention, however, together with additional objects and advantages thereof, will be best understood from the following description of specific embodiments when read in connection with the accompanying drawings.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a flow diagram illustrating the hybrid emergency call system according to an exemplary embodiment of the present invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

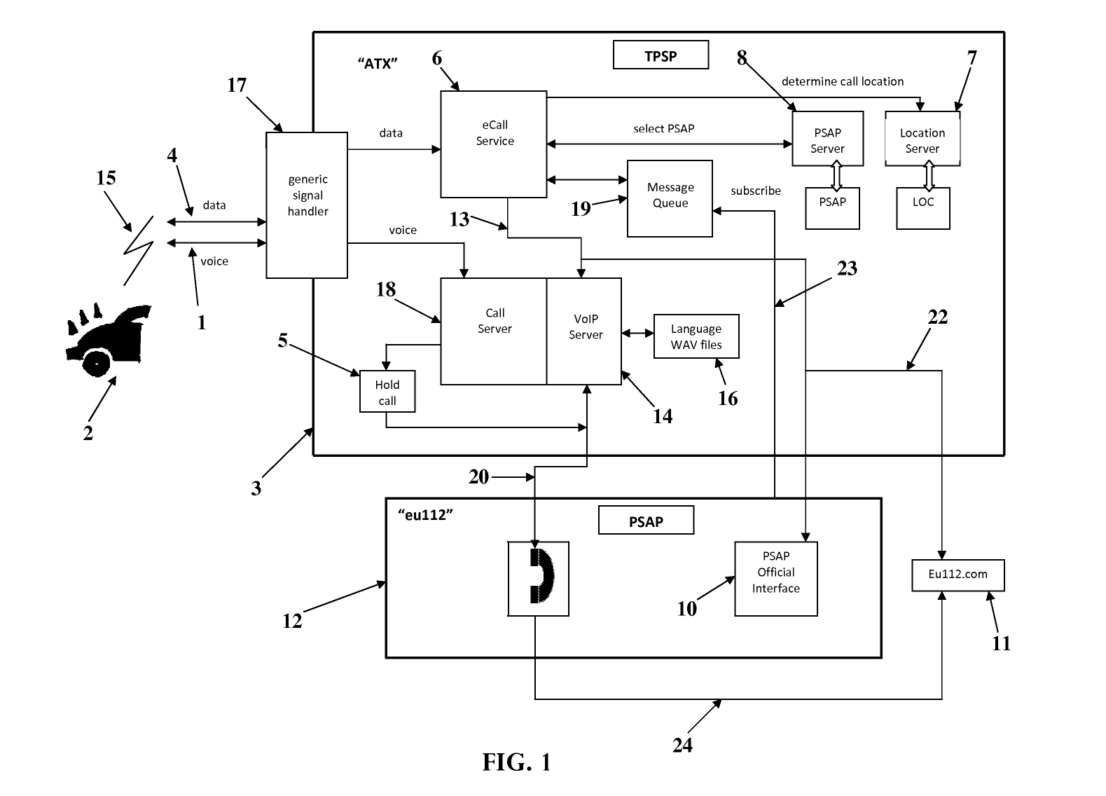

Referring now to FIG. 1 of the drawings in detail, there is shown, according to a first exemplary embodiment of the present invention, a flow diagram of the system architecture by which an emergency services call is received and processed. For purposes of providing an illustrative non-limiting example, this particular embodiment is shown as being used in connection with the existing “eu112” emergency call system of the European Union that is described above. However, the present invention is applicable to all emergency call services or systems that exist in various locations where it would be beneficial to have a “hybrid” solution between the public emergency call system and a third party services provider, and particularly where the public emergency call system covers a wide or diverse geographical region in which the speaking language varies over the region.

The system is initially triggered by an incoming emergency call 15 (referred herein as an “eCall”), such as a voice signal, from a motor vehicle 2 or mobile device that is relayed over a telecommunications channel 1. The transmission of the incoming emergency call 15 can, for example, be activated by a motorist depressing an in-vehicle emergency button or by in-vehicle equipment automatically dialing upon an emergency condition of the vehicle that is sensed by one or more sensors (e.g. airbag deployment). The signal is received by a generic signal handler 17 of a third party services provider 3 (depicted as “ATX” in FIG. 1), which may be comprised of a call center. In an exemplary embodiment, only a single third party services provider exists and covers the entire region, in this case being the European Union, such that all of the incoming emergency calls initially come through a single third party services provider 3. Simultaneously, and in parallel with the voice signal, a set of data that is generated by the emergency system inside the motor vehicle (e.g. from an in-vehicle satellite positioning technology) is transmitted to the generic signal handler 17 of the third party services provider using, for example, an in-band modem or SMS or any other available data channel 4. The generic signal handler serves as a central entry point at the third party services provider and its implementation depends on the OEM supported voice and data transmission protocols. In an exemplary embodiment, the voice and data signals may be transmitted using Data Over Voice (DOV) technology. The voice call is received from the generic signal handler 17 and is processed by a dedicated server 18 of the third party services provider (shown as “Call Server” in FIG. 1), and is placed on hold 5, either manually or automatically. Concurrently therewith, the data portion of the signal(s) received from the vehicle is processed by a dedicated server 6 of the third party services provider (shown as the “eCall Service” in FIG. 1) and decoded.

From the decoded data, a variety of pertinent information regarding the nature of the emergency can be determined that can include, but is not limited to, the event that triggered the emergency call or signal, the physical location and condition of the motor vehicle (e.g. from crash/sensor data originating from the vehicle), and the condition of the occupants inside the vehicle. For example, as shown in FIG. 1, a dedicated location server 7 of the third party services provider can critically determine the location of the motor vehicle. Once the location of the motor vehicle is known, a dedicated “Public Safety Answering Point” (PSAP) server 8 can then determine which PSAP 12 in the third party services provider's database is appropriate for responding to the emergency situation based upon the location of the motor vehicle and using internal logic.

Once the PSAP is selected, the “eCall” server 6 passes 13 the number and country code of the appropriate PSAP unit 12 to, for example, a “Voice over Internet Protocol” (VoIP) server 14 (shown as a component of the “Call Server” in FIG. 1). Thereafter, the “VoIP” server 14 routes 20 the call to the selected PSAP. The “VoIP” server converts all of the necessary data information, e.g. vehicle sensor data or vehicle location, into speech audio files in a target language using, for example, “text2speech” technology. The target language depends on the language of the selected PSAP. Thus, the “VoIP” server 14 transmits the audio files (e.g. WAV files) 16 that match the emergency call (“eCall”) 15 to a telephone or other communications portal of the selected PSAP in the language of the selected PSAP. As described by an example below, a unique identifier may be associated with the emergency call 15 to ensure that the correct pre-defined audio files are transmitted to the intended PSAP. Thus, once the “VoIP” server 14 has established communication with the intended PSAP 12, the “VoIP” server 14 plays announcements comprised of the “eCall” or other associated data to the PSAP in the target language thereby eliminating any language barrier that might exist between the motorist and the PSAP.

In an exemplary embodiment, the aggregated data is also sent 22 to the PSAP using one or more proprietary web interfaces 10, such as a collaborative interface between the PSAP and the third party services provider. Based on the “eCall” data received by the PSAP, further announcements could be played that indicate the nature of the emergency condition, such as for example, “Passenger-side airbag deployed.” Accordingly, the system of the present invention is able to detect the responsible area, language and preferred interface of the PSAP based on the position of the “eCall” issued.

The system of the present invention may also have a middleware system, shown as “Message Queue” 19 in FIG. 1, that provides a publish/subscribe model wherein a PSAP can subscribe 23 and identify the interface that it supports to the third party services provider. The third party services provider is then able to publish the incoming “eCall” data to the subscription, thereby ensuring that the same PSAP gets both the voice and data in the preferred form dictated by the PSAP interface.

It is contemplated that all PSAPs may not have developed interfaces, or that their existing interfaces are not capable or sophisticated enough to handle the amount or types of data produced by the motor vehicle's emergency system or other backend services. Therefore, an alternative data source, such as a high secure web portal 11 provided in connection with the third party services provider, can be accessed in a secure manner by the PSAP. For example, as shown in FIG. 1, the “eCall” payload could be stored or posted on a high secure web portal 11 (shown as “EU112.com” in FIG. 1) and requested or accessed 24 by the PSAP 12 via an access code provided by the third party services provider, which may be provided to the PSAP through the voice channel 16. Therefore, the system of the present invention provides a central multilingual client solution for all PSAPs.

After the voice and data signals are transmitted to the PSAP such that the PSAP has the most crucial information needed to initiate an emergency response, the “call server” hands over the voice call to the selected PSAP and direct communication is established between the motor vehicle emergency system, or the motorist, and the selected PSAP.

There are a great number of advantages of initially handling all emergency calls, or “eCalls,” through a single third party services provider, in the “hybrid” manner described above, prior to initiating the PSAP emergency system. For example, the complexity of a region-wide emergency call system falls primarily on the third party services provider such that any adjustments that need to be made can be quickly and cost-effectively implemented at the single level of the third party services provider instead of needing to make changes to the individual emergency call system units in the motor vehicles. Accordingly, the emergency call system of the present invention can be adapted to apply to all legacy customers of the existing vehicle emergency call systems.

In addition, as a conduit, the third party services provider can enrich the data applications that currently exist without implementing any changes to the individual emergency call system units in the motor vehicles or the PSAPs.

Also, the central position of the third party services provider and the fact that it is a separate entity in the overall system allows for it to have a large amount of flexibility to perform internal tests (e.g. crash tests or device acceptance tests) of the system without having to cause significant interruptions to the PSAPs. In addition, the third party services provider is in the prime position and vantage point for determining meaningful, system-wide statistics regarding the health and operations of the system. Moreover, unlike the PSAPs, the one or more device interfaces of the third party services provider are not bound by any official regulations and therefore, the third party services provider has the freedom to operate the data transmission in a larger variety of ways than may be possible in a regulated system.

Furthermore, because the single third party services provider centrally hosts all announcements going to the PSAPs and ensures that the voice and data portions of an emergency call are transmitted to the same PSAP, the system of the present invention is highly uniform and reliable and the costs typically associated with the maintenance and care of the existing systems is significantly reduced.

Also, the third party services provider can screen the incoming emergency calls, in the fluent native language of the motorist, to identify false alarms and confirm true emergencies and to re-prioritize non-emergencies.

In another example, as described above, the third party services provider can intercept any issues regarding language compatibility between a motorist and the appropriate PSAP in the case of cross border emergency services requests. The easy expansion of languages is possible without any changes to the hardware components of the system, such as the increase in storage space.

In a further example, the third party services provider can relieve the PSAPs of a majority of the call re-routing, retry or fallback functions that are currently operated by the PSAPs, thereby simplifying the task burden on the public services systems.

In addition, the country-specific interfaces to the PSAP are implemented by the third party services provider, thereby providing a uniform interface.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A hybrid emergency call system, comprising:
a third party service center for receiving an incoming wireless emergency signal from a remote location, the third party service center comprising:
at least one server that decodes information from the incoming wireless emergency signal including a location of the incoming wireless emergency signal;
at least one server that selects an appropriate public emergency call response center based upon the location of the incoming wireless emergency signal;
at least one server that converts the incoming wireless emergency signal into at least one audio file in a speaking language of the selected public emergency call response center; and
wherein the at least one audio file is relayed to the selected public emergency call response center over a telecommunications channel.

2. The hybrid emergency call system of claim 1, wherein the incoming wireless emergency signal is from a motor vehicle at the location.

3. The hybrid emergency call system of claim 2, wherein the incoming wireless emergency signal is comprised of a voice signal portion and a data signal portion.

4. The hybrid emergency call system of claim 3, wherein the data signal portion is the portion of the incoming wireless emergency signal that indicates the location of the incoming wireless emergency signal.

5. The hybrid emergency call system of claim 3, wherein the data signal portion of the incoming wireless emergency signal indicates the nature of an emergency and a condition of the motor vehicle.

6. The hybrid emergency call system of claim 3, wherein the data signal portion is the portion of the incoming wireless emergency signal that is converted into the at least one audio file.

7. The hybrid emergency call system of claim 3, wherein the at least one audio file is comprised of one or more announcements associated with the information decoded from the incoming wireless emergency signal.

8. The hybrid emergency call system of claim 3, wherein the third party service center puts the voice signal portion of the incoming wireless emergency signal on hold until after the at least one audio file is relayed to the selected public emergency call response center.

9. The hybrid emergency call system of claim 8, wherein the third party service center releases the voice signal portion of the incoming wireless emergency signal from being on hold and establishes a direct connection between the voice signal portion of the incoming wireless emergency signal and the selected public emergency call response center after the at least one audio file is relayed to the selected public emergency call response center.

10. The hybrid emergency call system of claim 3, wherein in addition to receiving the data signal portion of the incoming wireless emergency signal in the at least one audio file, the selected public emergency call response center directly also receives the data signal portion through at least one web interface.

11. The hybrid emergency call system of claim 10, wherein the at least one web interface is a preferred interface of the selected public emergency call response center.

12. The hybrid emergency call system of claim 10, wherein the at least one web interface is a collaborative agreed interface of the selected public emergency call response center and the third party service center.

13. The hybrid emergency call system of claim 10, wherein the at least one web interface is a high secure web portal in association with the third party service center wherein the selected public emergency response center has secured access to the web portal.

14. The hybrid emergency call system of claim 11, wherein the third party service center further comprises a middleware element wherein the selected public emergency call response center obtains a subscription to the middleware element such that the third party service center publishes the data signal portion of the incoming wireless emergency signal in the preferred interface.

15. The hybrid emergency call system of claim 13, wherein the selected public emergency response center is given an access code in the at least one audio file for accessing the web portal.

16. A method for providing a hybrid emergency call system, comprising:
receiving at a third party service center an incoming wireless emergency signal from a remote location;
selecting an appropriate public emergency call response center based upon a location of the incoming wireless emergency signal;
converting the incoming wireless emergency signal into at least one audio file in a speaking language of the selected public emergency call response center; and
relaying the at least one audio file to the selected public emergency call response center over a telecommunications channel.

17. The method of claim 16, wherein the incoming wireless emergency signal is from a motor vehicle at the location.

18. The method of claim 17, wherein the incoming wireless emergency signal is comprised of a voice signal portion and a data signal portion.

19. The method of claim 18, wherein in addition to receiving the data signal portion of the incoming wireless emergency signal in the at least one audio file, the selected public emergency call response center directly also receives the data signal portion through at least one web interface.

20. The method of claim 19, wherein the at least one web interface is a high secure web portal in association with the third party service center wherein the selected public emergency response center has secured access to the web portal.
